(19) United States
(12) Patent Application Publication
(10) Pub. No.: US 2006/0144510 A1
(43) Pub. Date: Jul. 6, 2006

(54) Automated media lamination system, method and printer for laminating recorded media

(75) Inventor: Daniel Paul Cahill, Verona, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/030,246

(22) Filed: Jan. 6, 2005

(51) Int. Cl. B32B 38/14; B32B 37/18; B32B 38/04; B32B 39/00

(52) U.S. Cl. 156/277; 156/267; 156/387; 156/538; 156/556

(57) ABSTRACT

A media lamination system (100) in the form of a printer includes a duplexor (540) capable of directing recording media and lamination media from a first storage tray (510a) and a second storage tray (510b), respectively, through a fuser (530) which bonds the lamination media to the recording media to created a laminated document. The duplexor (540) can flip or divert the recording media for two-sided printing and the fuser (530) characteristics can be altered to assist the bonding and accommodate various adhesives and thicknesses of the laminate media.

### TECHNICAL FIELD

The present invention relates generally to the lamination of documents and, more specifically, to a lamination system capable of bonding a sheet of laminate to a sheet of recorded print media. More specifically, the present invention relates to media lamination system having integrated image forming and document lamination functions eliminating the requirement for a post processing machine to laminate documents.

### BACKGROUND

Conventional image forming devices including copiers, laser printers, facsimile machines, and the like, typically include a drum having a rigid cylindrical surface that is coated along a defined length of its outer surface with a photoconductive material. The surface of the drum is charged to a uniform electrical potential and then selectively exposed to light in a pattern corresponding to an original image. Those areas of the photoconductive surface exposed to light are discharged thus forming a latent electrostatic image on the photoconductive surface. A developer material, such as toner, having an electrical charge such that the toner is attracted to the photoconductive surface is brought into contact with the photoconductive surface. The drum then rotates past an intermediate transfer media where the toner is transferred onto the media. A recording sheet, such as a blank sheet of paper, is then brought into contact with the intermediate transfer media and the toner thereon is transferred to the recording sheet in the form of the latent electrostatic image. The recording sheet is then heated thereby permanently fusing the toner to it. In preparation for the next image forming cycle, the photoconductive surface is discharged and residual toner is removed.

The lamination of printed documents is becoming more popular. For example, laminated printed sheet cards such as an ID or driver's license card are now commonplace. Typically, for lamination the recorded image media is sandwiched and hermetically sealed by a pair of transparent lamination sheet members whose size is slightly greater than the rectangular card.

In a conventional image forming device lamination of documents is typically accomplished using a post processing machine to add a protective cover to the printed page. Such a machine is capable of applying sufficient pressure and heat to activate an adhesive on the lamination media to cause bonding. Thus, for the lamination process, a special lamination device is provided in which the pair of lamination sheet members are pressed together and heat sealed at a relatively high temperature.

A typical laser printer includes a fixing device where a sheet of recording media is nipped between a heat roller and a pressure roller press melting the toner which has been transferred onto the sheet. To this effect, the fixing portion is adapted to generate a heating temperature of about 150 degrees C. Thus, the fixing portion of the laser printer is available for the lamination process in terms of heating and pressing the lamination sheet members.

In this regard, there has been proposed an image forming device capable of performing lamination process by allowing the lamination sheet members to pass through the sheet feed passage. For example, U.S. Pat. No. 5,894,314 (the '314 Patent) describes an image forming device having a lamination function. Essentially, with the device of the '314 patent and other similar machines, a printing device is configured to allow user assisted lamination of printed documents. Thus, with such devices the user is required to perform the following activities in order to obtain a laminated image:
They must print the image on a sheet
Remove the sheet from the printer
Sandwich that sheet between the laminating materials
Set the printer to lamination mode
Manually feed that back through the printer.

The automatic lamination of documents by an image forming device, such as a modem day laser printer would provide numerous advantages. A system that would automatically accomplish many, if not all, of the above tasks without user intervention is desired.

### BRIEF DESCRIPTION OF THE DRAWINGS

The present invention is illustrated by way of example and not limitation in the figures of the accompanying drawings in which like references indicate similar elements, and in which:

FIG. 1 is a side view illustrating an image forming apparatus according to one embodiment of the present invention;

FIG. 2 is a side view of a print cartridge including the developer assembly and cleaning assembly along with the doctor blade assembly according to one embodiment of the present invention;

FIG. 3 is a perspective view of automated lamination system according to one embodiment of the present invention; and

FIG. 4 is a process flow diagram for a method of automatically laminating documents according to the present invention.

### DETAILED DESCRIPTION

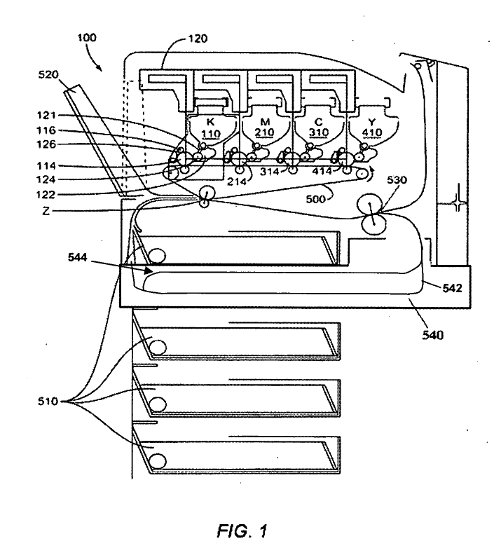

FIG. 1 illustrates the basic elements of an image forming device having an integrated and automatic lamination function according to the present invention. Specifically, FIG. 1 is a diagram representative of a four cartridge color laser printer, denoted generally as 100, which illustrates the essential components of an electro-photographic printer capable of automatically laminating printed documents. It should be understood, however, that those skilled in the art will understand that the present invention is applicable to other types of image forming systems using toner for printing with a photoconductor, such as a copier, mono-color laser printer, facsimile or the like. The printer, image forming system or image forming device (as the terms can be used interchangeably) is generally designated 100 and includes a plurality of similar toner or print cartridges 110, 210, 310, and 410. Each print cartridge 110, 210, 310 and 410 is of a similar construction but is distinguished by the toner color contained therein. In the embodiment shown, the device 100 includes a black (K) cartridge 110, a magenta (M) cartridge 210, a cyan (C) cartridge 310, and a yellow (Y) cartridge 410. Each different color toner forms an individual image of a single color that is combined in layered fashion to create the final multi-colored image.

Each of the print cartridges 110, 210, 310 and 410 is substantially identical and includes a photoconductor, a development assembly, and a cleaning assembly. As the print cartridges 110, 210, 310 and 410 are identical except for the toner color, the print cartridge 110 and elements for forming black images will be described with the other color image forming units being omitted for simplification.

A part of the image forming subsystem of printer 100 is photosensitive drum 114 which is generally cylindrically-shaped with at least one end that intermeshes with image forming device drive gears to provide for a rotational force. The photosensitive drum 114 has a smooth surface for receiving an electrostatic charge over the surface as the photosensitive drum 114 rotates past charging device 116. The photosensitive drum 114 uniformly rotates past a scanning laser 120 directed onto a selective portion of the photosensitive drum 114 surface forming an electrostatically latent image across the width of the photoconductor representative of the outputted image. The drive gears rotate the photosensitive drum 114 continuously so as to advance the photosensitive drum 114 a predefined distance between laser scans. This process continues as the entire image pattern is formed on the photoconductor surface.

After receiving the latent image, the photosensitive drum 114 rotates to another part of the image forming subsystem of the printer 100, namely a developer which has a toner bin, illustrated generally as 122 in FIG. 1. Toner bin 122 provides a toner housing which, in conjunction with a developer roller 124, is uniformly transferred to the photosensitive drum 114. Specifically, the toner is transferred from the toner bin 122 to the photosensitive drum 114 through a doctor blade nip formed between the developer roller 124 and a doctor blade assembly 121. The toner is a fine powder usually constructed of plastic granules that are attracted and cling to the areas of the photosensitive drum 114 that have been discharged by the scanning laser 120.

The photosensitive drum 114 next rotates past an adjacently-positioned intermediate transfer mechanism belt 500 (hereinafter, ITM belt) to which the toner is transferred from the photosensitive drum 114. As illustrated in FIG. 1, the ITM belt 500 is endless and extends around a series of rollers adjacent to photoconductors 114, 214, 314 and 414. The ITM belt 500 and each photosensitive drum 114, 214, 314, 414 are synchronized providing for the toner from each photosensitive drum 114, 214, 314 and 414 to precisely align on the ITM belt 500 during a single pass. By way of example as viewed in FIG. 1, the yellow toner will be placed on the ITM belt 500, followed by cyan, magenta, and black.

After depositing the toner on the ITM belt 500, the photosensitive drum 114 rotates through a cleaning area where residual toner is removed from the surface via a brush or scraper 126. The residual toner is moved along the length of the photosensitive drum 114 to a waste toner reservoir. In one embodiment, the photosensitive drum 114 further passes through a discharge area (not shown) having a lamp or other light source for exposing the entire photoconductor surface to light to remove any residual charge and image pattern formed by the scanning laser 120

As the photoconductors 114, 214, 314 and 414 are being charged and gathering toner, a recording sheet, such as a blank sheet of paper, is being routed to intercept the ITM belt 500. The paper may be placed in one of the storage trays 510, or introduced into the image forming device through a side track tray 520. As shown, a series of rollers and belts transport the paper to point Z where the sheet contacts the ITM belt 500 and receives the toner. Thus, the various rollers and belts comprise the printer's paper handling subsystem which transports media to the image forming subsystem. The fuser 530 fixes an image on the recording media. In this way, a sheet of recording media may receive an electrostatic charge prior to contact with the ITM belt 500 to assist in attracting the toner from the ITM belt 500. The sheet and attached toner next travel through a fuser 530 having a pair of rollers and a heating element that heats and fuses the toner to the sheet.

As shown in FIG. 1, printer 100 includes a duplexor 540 which can receive a sheet of media 542 and cause it to be returned to the image forming subsystem and fuser 530 in order to allow double sided printing and/or lamination according to the invention. This aspect of the duplexor is illustrated by pathway 544, which shows path traversed by a sheet of media when double sided printing has been requested. The technical details of implementing pathway 544 will not be described as such details are well known in the art. Nevertheless, it should be understood that in one embodiment duplexor 540 can receive a sheet of recording media and flip it and redirected it to photosensitive drum 114 for a second pass. Likewise, duplexor 540 can cause media 542 to make a second pass through fuser 530 in combination with a sheet of lamination media where it is bonded to the recording media to form a laminated document.

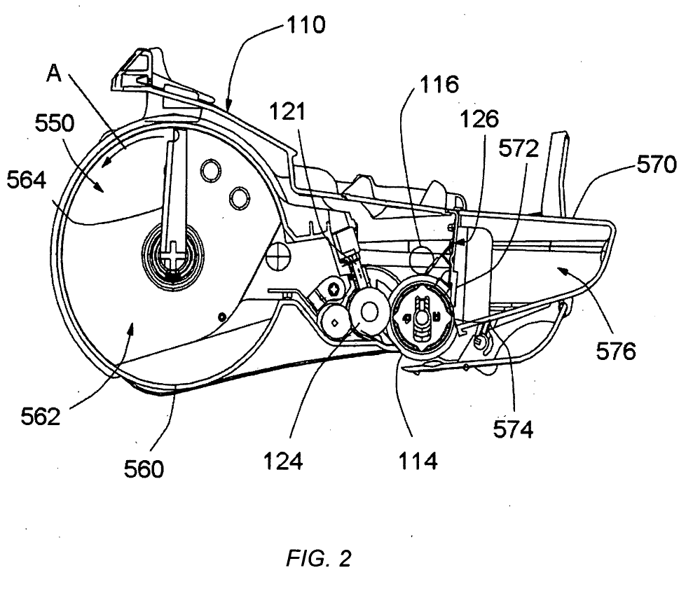

FIG. 2 illustrates the image forming functionality of a modern day laser printer, such as printer 100, in more detail. In general, print cartridge 110 constitutes a major component of the image forming subsystem for an image forming device, such as laser printer 100. The photosensitive drum 114 rotates and receives a uniform charge by charging device 116 which exposes a light image onto the photosensitive drum 114 to form a latent image on the photosensitive drum 114. A toner image corresponding to the latent image is formed by developer drum 550, thus making the image visible. After the toner image is transferred to the recording media, toner remaining on the photosensitive drum 114 may be removed by scraper 126 or other suitable cleaning means. These elements, including the photosensitive drum 114, are housed inside a development assembly 560 and cleaning assembly 570 which together constitute a housing that form the enclosure of the print cartridge 110. Each part of the print cartridge 110 is provided with a sealing member for preventing the toner from leaking.

As shown in FIG. 2, the development assembly 560 includes a toner well 562 for housing toner, and a rotary paddle toner feeding member 564. The toner feeding member 564 is provided within the toner well 562 and rotates as indicated in the direction of arrow A to circulate toner within the toner well 562. The developer roller 124 receives a thin toner layer on its surface (referred to as “doctoring surface”) as a result of its rotation and is pressed against the photosensitive drum 114. The doctor blade assembly 121 is disposed adjacent the developer roller 124 to regulate the thickness of the toner layer formed on the doctoring surface. The electric charge is imparted to the toner by a biasing voltage on the doctor blade assembly 121.

Cleaning assembly 570 comprises a cleaning blade 572 positioned in contact with the surface of the photosensitive drum 114 for scraping off the toner remaining on the photosensitive drum 114, a skimming seal 574, positioned below the cleaning blade 572 arranged in weak contact with the surface of the photosensitive drum 114, for retaining up the toner which has been scraped off, and a waste toner well 576 for storing the scraped-off waste toner.

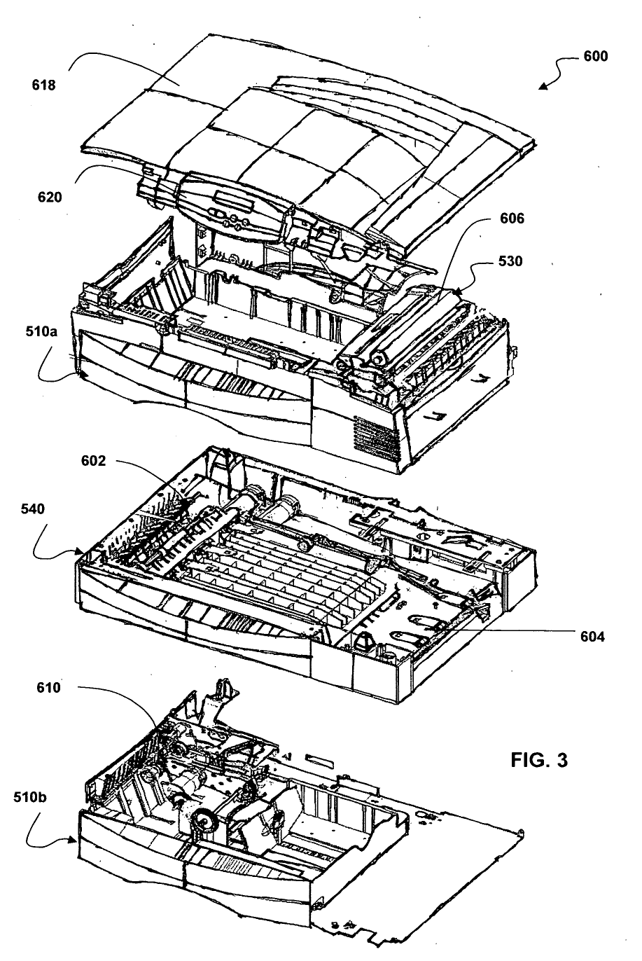

Accordingly, the present invention provides a media lamination system, method of automatically laminating documents and printer having an integrated laminator. The essential components for such a system illustrated in FIG. 3. Specifically, media lamination system, denoted generally as 600, includes a first storage tray 510a which functions as the primary media retention device for holding the recording media upon which images are formed. For example, first storage tray 510a may be the primary paper tray for holding recording media such as ordinary stock paper. System 600 also comprises a secondary storage tray 510b in which lamination media (not shown) can be stored. The lamination media may comprise clear pre-cut sheets of plastic of the type suitable for laminating documents. The lamination media may include an adhesive which, when subject to pressure and/or heat, may bond to a sheet of recording media.

Fuser 530 functions according to known designs. In one embodiment, the temperature and/or pressure characteristics of the fuser 530 may be altered in order to facilitate the bonding of lamination media to recording media. For example, the speed by which media is transported through the fuser 530 may be reduced in order to assist the bonding of the lamination media. Likewise, pressure may be applied by roller 606 of fuser 530 to media passing though fuser 530 in order to facilitate bonding. Finally, the heat provided by the fuser's heating element (not shown) can be raised in order to assist the bonding of the laminate media.

The laminate media may be stored in storage tray 510b and transported to the fuser 530. A pickup 610 is provided to help transport the laminate media through the system's paper handling subsystem. In this way, a desired image may first be recorded on a sheet of recording media from the first storage tray 510a and a sheet of lamination media from the second storage tray 510b may be bonded to the sheet of recording media thereby laminating the sheet of recording media.

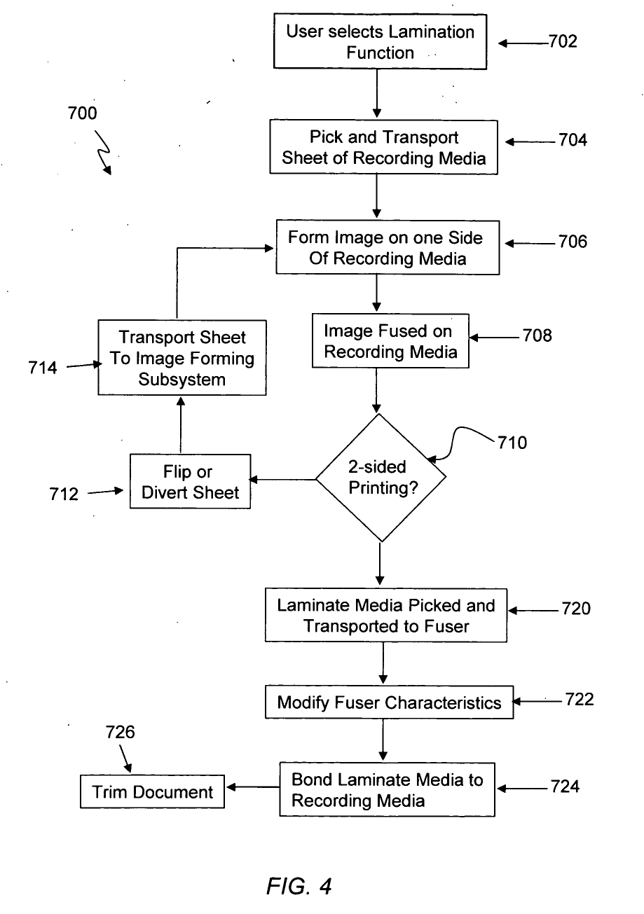

System 600 includes a top 618 having control panel 620 which provides various user selectable functions. It is contemplated that a user of system 600 can select a lamination function from the control panel 620 to cause system 600 to laminate documents or control the lamination process through the data stream by use of a computer. With reference to FIG. 4, a process flow diagram for a method of automatically laminating documents according to one embodiment of the present invention is shown and denoted generally as 700. In general, method 700 begins at step 702 when a user selects the lamination function. Next, at step 704, a sheet of recording media is picked and transported to an image forming subsystem of a printer, such as printer 100, as described herein. Next, an image is formed on one side of the recording media, step 706. The imaged sheet is transported to a fusing device, step 708, wherein the image is fixed to the sheet.

Next, at decision block 710, it is determined if two-sided printing has been selected and, if so, process flow is directed to step 712 wherein the sheet is flipped to a second side by a duplexing unit, such as duplexor 540. Alternatively, a diverter is used to pass the sheet beneath the printing system and return it to the input side of the printer without flipping. In either case, process flow continues at step 714 wherein the recording media is transported to an image forming subsystem of a printer allowing an image to be formed in the second side of the recording media, step 706, substantially in the same way as before.

If single side printing is selected or if both sides have been imaged and fused, process flow continues to step 720 wherein the lamination media is picked from a storage tray and transported to a fusing device, such as fuser 530. To facilitate bonding of the laminate media to the recording media the fuser characteristics may be altered, step 722. This may involve reducing the speed of the fuser or increasing the pressure and/or temperature of the fuser in order to accommodate different adhesives and/or laminate thicknesses. In any event, at step 724, the fusing device causes the laminate media to be bonded to the recording media creating a laminated document. As this point, the laminated document may be trimmed to remove excess laminate, step 726.

Thus, the present invention provides a method of automatically laminating documents that involves fixing an image on a sheet of recording media and bonding a sheet of laminate to the sheet of recording media utilizing a fusing device within an image forming system to create a laminated document.

It should be understood that modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A media lamination system comprising:
first storage tray for holding a supply of recording media;
second storage tray for holding a supply of lamination media;
a fuser capable of fixing an image on a sheet of recording media and bonding a sheet of lamination media to a sheet of recording media; and
a paper handling subsystem for transporting recording media from the first storage tray and for transporting lamination media from the second storage to said fuser;
wherein a desired image is first recorded on a sheet of recording media from the first storage tray and wherein a sheet of lamination media from said second storage tray is then bonded to said sheet of recording media thereby laminating said image on said sheet of recording media.

2. The system of claim 1 further comprising an image forming subsystem for creating a desired image on a sheet of said recording media.

3. The system of claim 2 wherein said paper handling subsystem includes a duplexor for transporting said sheet of recording media from said image forming subsystem to said fuser.

4. The system of claim 3 wherein said duplexor causes said sheet of recording media to pass twice through said fuser, one time for fixing an image on said sheet of recording media and a second time for laminating a sheet of lamination media on said sheet of recording media.

5. The system of claim 3 wherein said duplexor causes said sheet of recording media to pass three times through said fuser, one time for fixing an image to a first side of said sheet of recording media, a second time for fixing an image on a second side of said sheet of recording media and a third time for laminating a sheet of lamination media to said sheet of recording media.

6. The system of claim 5 wherein said duplexor flips said sheet of recording media between said first and second passes.

7. The system of claim 3 wherein said duplexor includes a deflector for directing recording media to the input side of said image forming subsystem thereby eliminating the need to flip a sheet of recording media for double-sided printing.

8. A method of automatically laminating documents comprising the steps of:
fixing an image on a sheet of recording media; and
bonding a sheet of laminate to said sheet of recording media; wherein said fixing step and said bonding step utilize a fusing device within an image forming system to create a laminated document.

9. The method of claim 8 wherein said fixing step further comprising the steps of: printing a first image on a first side of said sheet of recording media; and printing a second image on a second side of said sheet of recording media.

10. The method of claim 9 further comprising the step of flipping said sheet of recording media prior to said second printing step.

11. The method of claim 8 further comprising the step of raising the temperature of said fusing device prior to said bonding step.

12. The method of claim 8 further comprising the step of a paper handling subsystem picking said sheet of recording media and said sheet of laminate and transporting them to said fusing device.

13. The method of claim 12 further comprising the step of said paper handling device reducing the speed with which it transports said sheet of laminate through said fusing device prior to bonding with said sheet of recording media.

14. The method of claim 8 further comprising the step of using high pressure and heat to bond said sheet of laminate to said sheet of recording media.

15. The method of claim 8 further comprising the step of trimming said sheet of recording media and said sheet of laminate after said bonding step.

16. A printer having an integrated laminator comprising:
first and second storage trays for holding a supply of recording media and lamination media, respectively;
an image forming subsystem for recording images unto one or more sides of a sheet of recording media;
a fuser for fixing said images on said one or more sides of said sheet; and
a paper handling subsystem for transporting recording media and lamination media from said first and second storage trays to said image forming subsystem and said fusing subsystem;
wherein a desired image is first recorded on a sheet of recording media from the first storage tray and wherein a sheet of lamination media from said second storage tray is then bonded to said sheet of recording media thereby laminating said image on said sheet of recording media.

17. The printer of claim 16 wherein said paper handling subsystem includes a duplexor for transporting said sheet of recording media from said image forming subsystem to said fuser.

18. The printer of claim 17 wherein said duplexor causes said sheet of recording media to pass twice through said fuser, one time for fixing an image on said sheet of recording media and a second time for laminating a sheet of lamination media on said sheet of recording media.

19. The printer of claim 17 wherein said duplexor causes said sheet of recording media to pass three times through said fuser, one time for fixing an image to a first side of said sheet of recording media, a second time for fixing an image on a second side of said sheet of recording media and a third time for laminating a sheet of lamination media to said sheet of recording media.

20. The printer of claim 19 wherein said duplexor flips said sheet of recording media between said first and second passes.

21. The printer of claim 17 wherein said duplexor includes a deflector for directing recording media to the input side of said image forming subsystem thereby eliminating the need to flip a sheet of recording media for double-sided printing.

22. The printer of claim 16 wherein said fuser is capable of applying sufficient pressure to activate an adhesive on said lamination media.

23. The printer of claim 16 wherein said fuser is capable of applying sufficient heat to activate an adhesive on said lamination media.

24. The printer of claim 16 wherein the speed of said fuser is decreased during the bonding of said lamination media to said recording media.
